(19) United States
(12) Patent Application Publication
(10) Pub. No.: US 2006/0294005 A1
(43) Pub. Date: Dec. 28, 2006

(54) Universal e-money brokerage service and method

(76) Inventor: David Drepak, Jerusalem (IL)

Correspondence Address: DR. MARK FRIEDMAN LTD.;C/O BILL POLKINGHORN, 9003 FLORIN WAY, UPPER MARLBORO, MD, 20772, US

(21) Appl. No.: 11/159,173

(22) Filed: Jun. 23, 2005

(51) Int. Cl. G06Q 40/00

(52) U.S. Cl. 705/39

(57) ABSTRACT

A universal e-money system and corresponding method for financial transactions involving different online payment systems includes local brokerage accounts opened with each online payment system, and software modules programmed in a computer in communication with the online payment systems. The modules interface with a first online payment system to identify receipt from a user of the first online payment system of a first electronic money transfer to a first local brokerage account and credit a virtual account of the user with a related value of electronic money. The modules also interface with the user to receive a request to complete a payment to a vendor having an account on a second online payment system. The virtual account of the user is debited and the requested payment is effected within a second online payment system from the local brokerage account to the vendor account.

### FIELD AND BACKGROUND OF THE INVENTION

The present invention relates to internet commerce and, in particular, it concerns a system and method for performing financial transactions involving a plurality of electronic money systems.

The field of internet commerce continues to grow at a staggering rate, and it has become common to purchase virtually all types of goods and services online. While direct online payment via credit card remains a common option, vendors often provide an alternative, preferred by many customers, of payment via an electronic money payment system such as PayPal, E-Gold, EVOcash, WebMoney, Moneybookers and E-Bullion.

Electronic money payment systems typically operate as follows. First a user opens an account by providing various information and the user's identity is verified. Then the user transfers funds from a conventional financial institution to the payment system, thereby purchasing electronic money credit in his or her account. The user can then issue an order for payment through which the required value of electronic money is transferred from the user's account to a vendor's account within the same payment system. The vendor can then either use the credit for his own purchases via the payment system, or can change the electronic money back into “real” money by requesting a transfer from his account to a conventional bank.

While these electronic money payment systems have become very popular, they impose various limitations which can be inconvenient to users and, in some cases, exclude potential customers altogether. Specifically, payments must be performed between two accounts within the same electronic money payment system since the different systems are in competition and do not have any direct interface between them. Thus, with reference to FIG. 1, this shows schematically the architecture of two electronic money payment services labeled “Service A” and “Service B”. Vendor 1 has an account with Service A while Vendor 2 has an account with Service B. This renders it convenient for User 1 who has an account with Service A to purchase from Vendor 1. To do this, he or she simply transfers funds from a conventional financial institution to Service A to purchase credit for his account and then instructs Service A to transfer the required funds to the account of Vendor 1, thereby completing a purchase.

If however User 1 is interested in purchasing goods or services from Vendor 2, he immediately encounters a problem. His account with Service A cannot be used to purchase from Vendor 2 since Vendor 2 does not have an account with Service A and there is no way to transfer funds directly between the services. Instead, User 1 may be forced to go through a complicated and time consuming sign-up and verification process to open an account with Service B in order to complete a purchase.

A further problem is likely to be encountered by users wishing to purchase goods or services internationally. In many cases, users from certain locations may be barred from opening accounts with certain electronic money payment systems. Thus, for example, it is common for US systems to bar users with IP addresses in the Russian Federation from opening accounts due to the “high risk” assessment of credit transactions originating there. As a result, Russian users cannot complete electronic money transactions with US businesses. Furthermore, even where the geographic region of origin of a foreign user is not per se excluded, many users may have a credit card which is limited to domestic use in the local currency of their country of origin such that they cannot use it to purchase credit in a payment system based in another country. In either of these cases, while User 1 of FIG. 1 may be able to open an account and complete transactions with a Service A located in his own country, he may be unable to open an account on Service B located abroad and therefore unable to complete a transaction with Vendor 2.

There is therefore a need for a system and method which would facilitate inter-system electronic money payments without requiring a user to open a separate account in each system through which he wishes to make a payment. It would also be highly advantageous to provide a system and method which would circumvent the limitations of regions with poor credit ratings and region-limited credit cards.

### SUMMARY OF THE INVENTION

The present invention is a system and method for performing financial transactions involving a plurality of online payment systems.

According to the teachings of the present invention there is provided, a method for performing financial transactions involving a plurality of online payment systems comprising: (a) opening a first and a second local brokerage account with a first and a second online payment system, respectively; (b) receiving from a user of the first online payment system a first electronic money transfer within the first online payment system from an account of the user to the first local brokerage account; (c) crediting a virtual account of the user with a value of electronic money related to the first electronic money transfer; (d) receiving from the user a request to complete a payment to a vendor having a vendor account on the second online payment system; (e) debiting the virtual account of the user with a value of electronic money related to the requested payment; and (f) transferring the requested payment within the second online payment system from the second local brokerage account to the vendor account.

According to a further feature of the present invention, a current exchange rate between two currencies interrelated by a fluctuating rate of exchange is retrieved, the current exchange rate being used in calculating the value of electronic money for at least one of the crediting and the debiting.

According to a further feature of the present invention, an initial registration procedure for at least one user is performed, the registration procedure including inputting information sufficient to identify a user account associated with the user on one of the plurality of online payment systems.

According to a further feature of the present invention, receipt of electronic money transfers from users of the second online payment system to the second local brokerage account is identified, and requested payments from the first local brokerage account to vendor accounts within the first online payment system are transferred.

There is also provided according to the teachings of the present invention, a universal e-money system for performing financial transactions involving a plurality of online payment systems, the system comprising: (a) a first and a second local brokerage account opened with a first and a second online payment system, respectively; and (b) a plurality of software modules programmed in a computer of a data network, the computer being in communication with the plurality of online payment systems, the plurality of modules being configured to: (i) interface with the first online payment system to identify receipt from a user of the first online payment system of a first electronic money transfer within the first online payment system from an account of the user to the first local brokerage account; (ii) credit a virtual account of the user with a value of electronic money related to the first electronic money transfer; (iii) interface with the user to receive from the user a request to complete a payment to a vendor having a vendor account on the second online payment system; (iv) debit the virtual account of the user with a value of electronic money related to the requested payment; and (v) interface with the second online payment system to transfer the requested payment within the second online payment system from the second local brokerage account to the vendor account.

According to a further feature of the present invention, the plurality of modules is further configured to retrieve a current exchange rate between two currencies interrelated by a fluctuating rate of exchange, the current exchange rate being used in calculating at least one of the value of electronic money to credit the virtual account and the value of electronic money to debit the virtual account.

According to a further feature of the present invention, the plurality of modules is further configured to interface with at least one user to perform an initial registration procedure, the registration procedure including inputting information sufficient to identify a user account associated with the user on one of the plurality of online payment systems.

According to a further feature of the present invention, the plurality of modules is further configured to interface with the second online payment system to identify receipt of electronic money transfers from users of the second online payment system to the second local brokerage account, and to interface with the first online payment system to transfer requested payments from the first local brokerage account to vendor accounts within the first online payment system.

There is also provided according to the teachings of the present invention, a program storage device readable by a machine, tangibly embodying a program of instructions executable by the machine to perform a method for performing financial transactions between users of a first and a second online payment system within which have been opened a first and a second local brokerage account, respectively, the method comprising the steps of: (a) receiving from a user of the first online payment system a first electronic money transfer within the first online payment system from an account of the user to the first local brokerage account; (b) crediting a virtual account of the user with a value of electronic money related to the first electronic money transfer; (c) receiving from the user a request to complete a payment to a vendor having a vendor account on the second online payment system; (d) debiting the virtual account of the user with a value of electronic money related to the requested payment; and (e) transferring the requested payment within the second online payment system from the second local brokerage account to the vendor account.

According to a further feature of the present invention, the method performed by the machine executing the program of instructions further includes retrieving a current exchange rate between two currencies interrelated by a fluctuating rate of exchange, the current exchange rate being used in calculating the value of electronic money for at least one of the crediting and the debiting.

According to a further feature of the present invention, the method performed by the machine executing the program of instructions further includes performing an initial registration procedure for at least one user, the registration procedure including inputting information sufficient to identify a user account associated with the user on one of the plurality of online payment systems.

According to a further feature of the present invention, the method performed by the machine executing the program of instructions further includes identifying receipt of electronic money transfers from users of the second online payment system to the second local brokerage account, and transferring requested payments from the first local brokerage account to vendor accounts within the first online payment system.

### BRIEF DESCRIPTION OF THE DRAWINGS

The invention is herein described, by way of example only, with reference to the accompanying drawings, wherein:

FIG. 1, described above, is a schematic representation of the conventional topography of online payment services illustrating the relationship of a user with vendors having accounts with two payment services;

FIG. 2 is a schematic illustration of the topology of a system and method for online payments, constructed and operative according to the teachings of the present invention;

FIG. 3 is a block diagram illustrating a preferred implementation of the system of FIG. 2 and its interconnections;

FIG. 4 is a flow diagram illustrating the operation of the system of FIG. 2 and the corresponding method of the present invention;

FIG. 5 is a flow diagram illustrating operation of a preferred implementation of a user interface module from the system of FIG. 2;

FIG. 6 is flow diagram illustrating operation of a preferred implementation of a funds verification process performed by certain embodiments of the present invention; and

FIG. 7 is a flow diagram illustrating operation of a preferred implementation of local brokerage account management process performed by certain embodiments of the present invention.

### DESCRIPTION OF THE PREFERRED EMBODIMENTS

The present invention is a system and method for performing financial transactions involving a plurality of online payment systems.

The principles and operation of systems and methods according to the present invention may be better understood with reference to the drawings and the accompanying description.

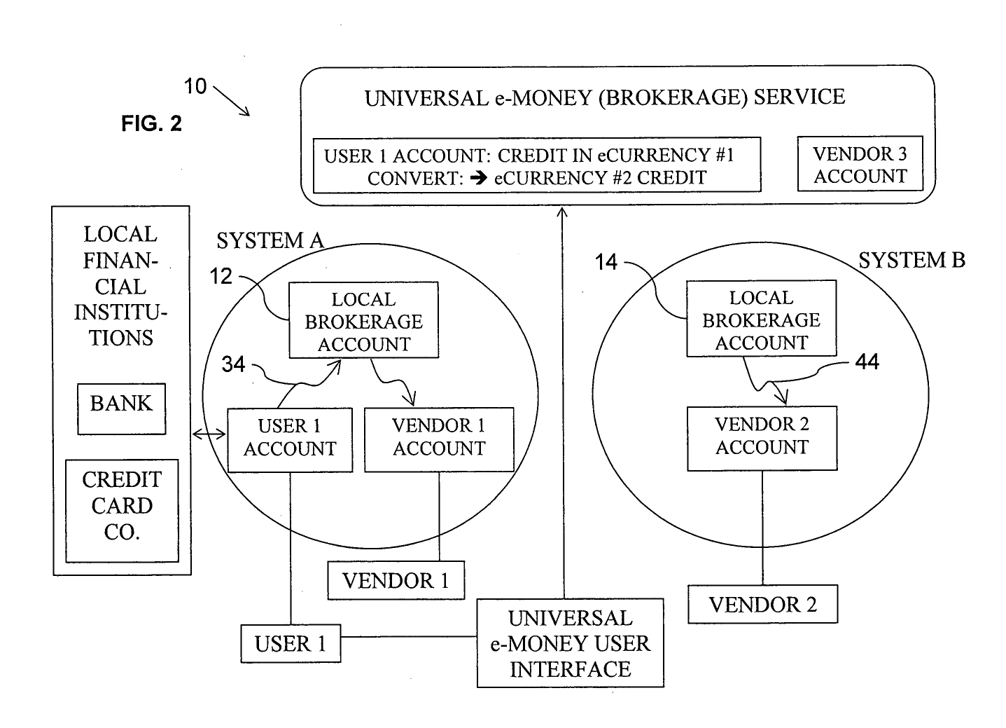

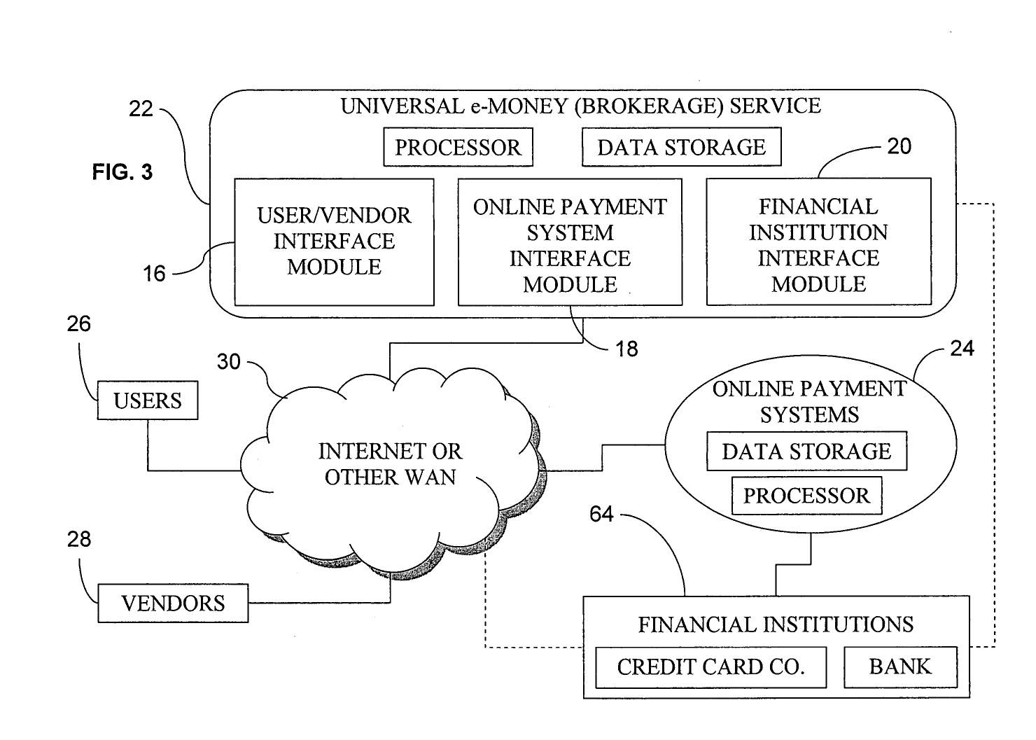

Referring now to the drawings, FIGS. 2-7 illustrate the structure and operation of a system, generally designated 10, constructed and operative according to the teachings of the present invention, for performing financial transactions involving a plurality of online payment systems, and the corresponding method according to the teachings of the present invention. In general terms, system 10, referred to herein as a “Universal e-Money Brokerage Service” or more colloquially as a “Global Money”™ system, includes local brokerage accounts 12, 14 opened with each of a plurality of online payment systems, illustrated in FIG. 2 as “System A” and “System B”. The system also includes a plurality of software modules, for example, modules 16, 18, 20 illustrated in FIG. 3, programmed in a computer 22 of a data network. Computer 22 is in communication with the plurality of online payment systems (designated collectively in FIG. 3 by numeral 24) and with customers of system 10 who may be users 26 or vendors 28 (or both). Communication between computer 22 and online payment systems 24, users 26 and vendors 28 is typically achieved at least in part by use of secure data communications over the internet 30 or other wide area network(s) (WAN), as is known in the art.

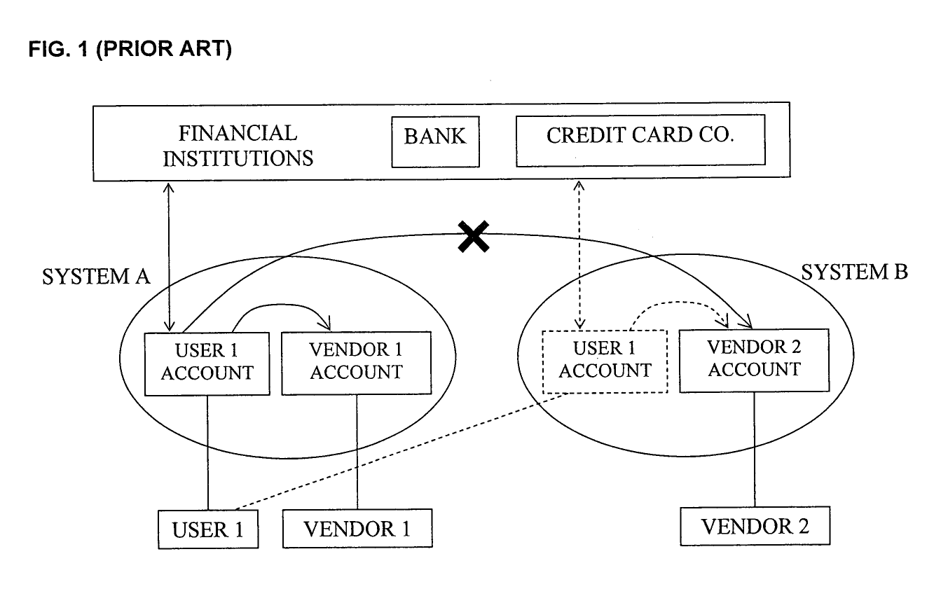

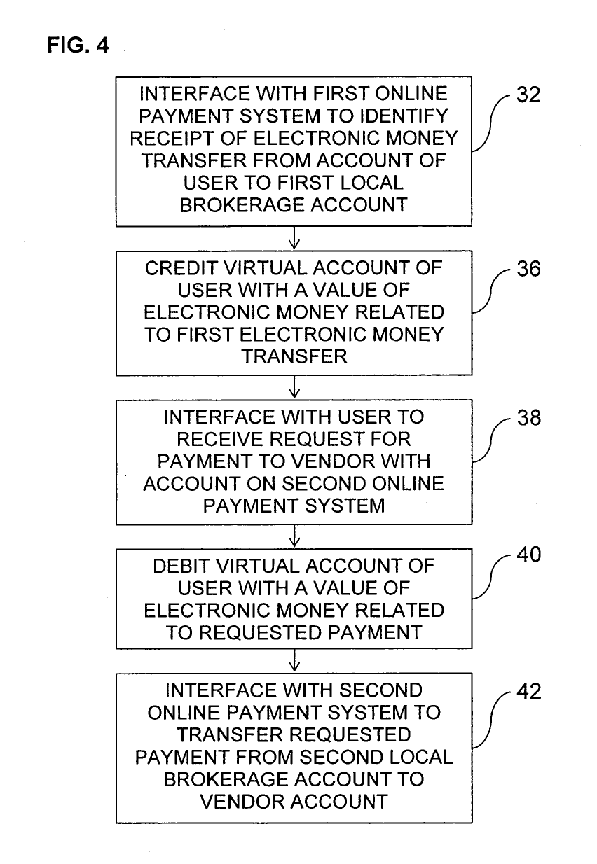

The operation of system 10 and the corresponding method of the present invention will now be understood with reference additionally to FIG. 4. After opening of a local brokerage account with each of the online payment systems, the plurality of modules are preferably configured to identify receipt to one of the local brokerage accounts of a first electronic money transfer from the account of a user on the same electronic payment system (step 32). In FIG. 2, this first transfer is represented schematically by an arrow 34 from “User 1 Account” to the “Local Brokerage Account” 12 in System A. The virtual account of the user with system 10 is then credited with a value of electronic money related to the first electronic money transfer (step 36). The credited value may be either of equal value to the transfer, or may have a handling charge deducted therefrom. The credit may be given in the same units as the original transfer or in different units, for example related by a variable currency exchange rate, as will be discussed further below. To use this credit, the user accesses an interface through which he or she submits a request to effect payment to a vendor (step 38). Unlike the prior art systems of FIG. 1, according to the present invention, the vendor need not have an account with the same online payment system as the user. Nor does the vendor need to have an account with system 10. Instead, the system debits the virtual account of the user with a value of electronic money related to the requested payment (step 40) and transfers the requested payment within the second online payment system from the second local brokerage account to the vendor account (step 42 and arrow 44 in FIG. 2). Here too, the debited value may be either of equal value to the transfer, or may have a handling charge added thereto, and may be deducted in the same units as the transferred payment or in different units.

At this stage, it will be readily apparent that the present invention offers numerous profound advantages over the prior art systems as illustrated in FIG. 1. Specifically, there is no need for a user to open an account with the same online payment system as used by the vendor in order to complete a payment transaction, thereby removing a major inhibiting factor against customer purchases from vendors using different online payment systems. Furthermore, with regard to international transactions, the present invention circumvents the problems of poor credit ratings and regionally limited credit cards by leaving interactions with financial institutions to the local online payment systems who are already familiar with the local financial institutions and already have reliable local verification procedures in operation. As a result, even a user with an online payment system account in a local system within the Russian Federation and whose credit card is limited to transactions in his country of origin can open a virtual account on system 10 and is immediately free to complete transactions with other users/vendors on substantially any online payment system anywhere in the world.

Before addressing the features of the present invention in more detail, it will be useful to clarify certain terminology as used herein in the description and claims. Firstly, reference is made to “users” and “vendors” in order to clearly illustrate the present invention in the context of one or more transaction in which a “user” purchases goods or services from a “vendor” and needs to effect a corresponding payment to the vendor. It will be appreciated that this distinction is somewhat arbitrary since the roles of user and vendor are interchangeable in that a vendor for one transaction may become the user in another transaction. In most preferred implementations of the present invention, the functionality of the system is symmetrical so that a user on any online payment system can both transfer funds to the local brokerage account and receive transfers therefrom depending upon whether he is a user or vendor for a given transaction.

Reference is also made to “software modules programmed in a computer of a data network”. It should be noted that, for the purpose of this description and the accompanying claims, the term “computer” is used to refer to any processing system including one or more microprocessor which is capable of performing the various functions recited herein. The “computer” may be a single machine located in a single location or may be a combination of physically separate machines working together to provide the recited functions, all as is known in the art. The “modules” of the present invention may be implemented in any manner known to one skilled in the art of software engineering, and are typically implemented as software modules programmed in any suitable language and operating under any suitable operating system. Alternatively, part or all of the various modules may be implemented using dedicated hardware and/or hardware-software combinations, also as is known in the art.

It should also be noted that the particular subdivision of the recited functions of the present invention between various modules is somewhat arbitrary, and the specific examples of modules and their functions described or implied by the present description and drawings may be varied considerable within the capabilities of one ordinarily skilled in the art.

The online payment systems (“O.P.S.”) referred to herein are existing computer systems or similar computer systems which allow users to manage an electronic money account, transfer money from existing financial institutions to purchase credit, and transfer credit to other user accounts of the same O.P.S. These systems are implemented as computer systems including one or more processors and associated data storage devices and provide user interfaces via encrypted communication via the internet, all as is well known in the art.

Turning now to the features of the present invention in more detail, as mentioned earlier, the system preferably allows cross-currency transfers. In the most general case, each online payment system “A” and “B” and system 10 itself may all employ electronic money tied to three independent currencies. Thus, by way of one non-limiting example, a user may transfer e-money in units tied to Euros within a local European payment system to local brokerage account 12, may be credited in his virtual account with units tied to US Dollars, and may choose to transfer funds to a Tokyo-based vendor via local brokerage account 14 in a local Japanese online payment system based on Yen. In the aforementioned example, on receipt of the Euro-based transfer, system 10 retrieves a current Euro-Dollar exchange rate for use in calculating the value of electronic money for crediting the virtual user account. Then, immediately prior to transferring the Yen-based payment, system 10 retrieves a current Dollar-Yen exchange rate for use in calculating the value of electronic money for debiting the virtual user account. The exchange rate retrieved may be a representative (average) rate or a buy/sell bank rate which includes a profit margin, and the retrieved rate may be modified by a preset percentage so as to add or change of profit margin. Furthermore, a conversion commission, either as a fixed transaction charge or a percentage, may be subtracted from the credit and/or added from the debit. Technology for real-time retrieval of currency exchange rates for online transactions is, per se, well developed, and will not be described herein in further detail. It is important to note that, in most cases, no currency actually needs to be converted by system 10 since each local brokerage account serves both for local incoming transfers and local outgoing transfers, acting as a pool of local currency funds.

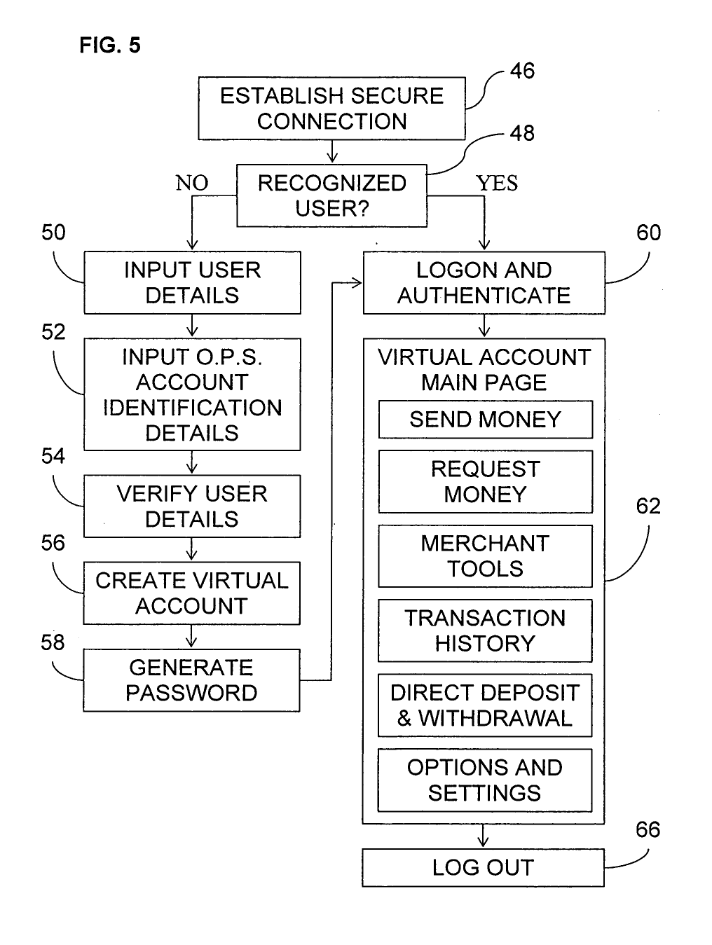

Turning now to the plurality of modules of computer 22, it is believed that implementation of these modules as software modules implemented as executable program code running under as suitable operating system on suitable processor(s) with associated data storage devices is well within the capabilities of one ordinarily skilled in the art from the description of the systems functions described thus far. Accordingly, the modules will not be described herein in detail. Nevertheless, by way of one non-limiting preferred example, the main features of one preferred implementation of the user interface module 16 will now be described with reference to FIG. 5.

Thus, user interface module 16 as illustrated here starts by establishing a secure connection between computer 22 and the user (step 46) and then proceeds to determine (typically by querying the user) whether he or she is a registered user (step 48). It will be appreciated that the order of steps 46 and 48 may be reversed, although the use of a secure initial page may allow direct logon from the entry page for registered users.

In the event that the user does not yet have a virtual account with the system, user interface module 16 then preferably enters an initial registration procedure which includes inputting user details (step 50) and also inputting information sufficient to identify a user account associated with the user on one of the online payment systems (“O.P.S.”) (step 52). This latter step is particularly significant since it may be necessary in order to allow the system to identify the source of incoming transfers to a local brokerage account. The module then typically verifies the user details (step 54), creates the user's virtual account (step 56) and generates a password and any other logon information required by the user for an initial authenticated logon to the system (step 58). Clearly, alternative verification techniques such as biometric sensor identification may replace password authentication as is known in the art.

After the registration procedure, or if the user already has an account, the user proceeds to a logon and authentication step 60 which, if successful, preferably directs the user to the main (home) page for managing his virtual account (step 62). Operations available from the main page preferably include one or more of the following:

“Send money” to initiate a payment from the virtual account to a recipient. The recipient may be on the same online payment system as the user (Vendor 1 of FIG. 2), on a different online payment system (Vendor 2), or may have a virtual account with system 10 (Vendor 3) to which credit may be transferred directly within the system.

“Request money” may be used to initiate a payment from the user's own O.P.S. account via system 10, or to request a money transfer from any other party having an account on a given O.P.S. Here again, the user/vendor requesting payment does not need to have an account on the same O.P.S. as the payer since payment is through transfer within the O.P.S. to the local brokerage account followed by a corresponding credit to the user/vendor's virtual account with the system.

“Merchant tools” provides generally standard tools of particular use to vendors.

“Transaction history” provides a history of transactions previously executed, their statuses, and current balance details.

“Direct deposit & withdrawal” provides additional options where desired for a user to deposit funds to his virtual account and/or withdraw funds by direct interaction with standard financial institutions. This adds the conventional functionality of an online payment system as an alternative option for users who prefer to provide and withdraw funds in this manner. For this reason, system 10 may have a communication link with one or more financial institutions 64, directly or via the internet, as illustrated by dashed lines in FIG. 3.

“Options and setting” typically provides a range of user options and additional features wherein the user can change his profile and/or set options such as confirmation messages and SMS notification settings.

After completion of the user operations, the user proceeds to log out at step 66, thereby terminating the user interface session.

Parenthetically, it should be noted that, as mentioned earlier, the system is preferably symmetrical with regard to “users” and “vendors”. Thus, in addition to allowing a “user” to effect a payment to a vendor not having an account with system 10, the system preferably also allows a “vendor” to receive payments from users not having an account with system 10. In the latter case, a transfer may be made to the local brokerage account in the user's O.P.S. with an email header specifying the email address or other identifying information of the vendor. After verifying the payment, the system then credits the virtual account of the vendor in system 10 with the corresponding credit.

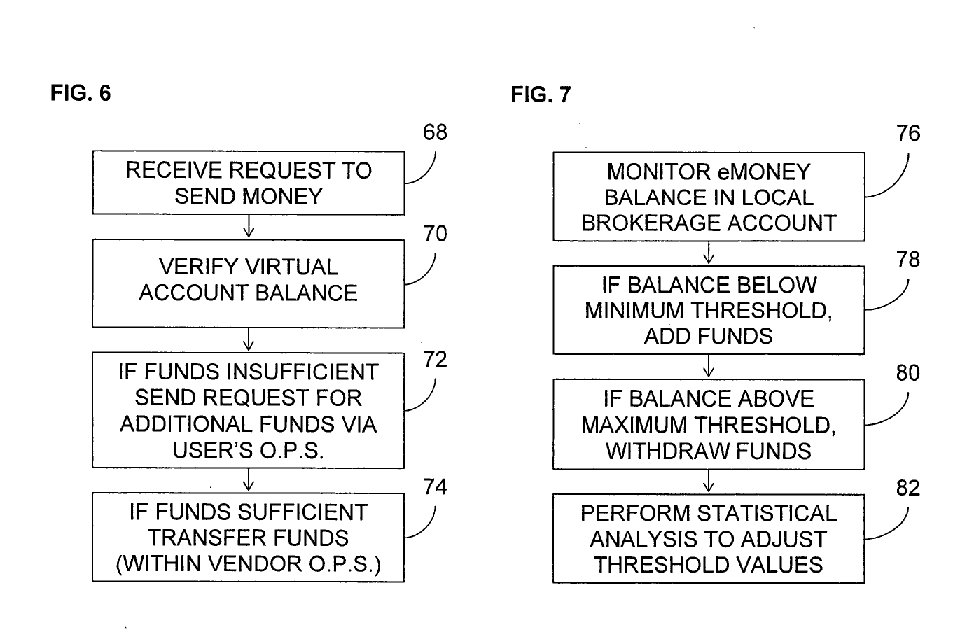

Turning briefly to FIG. 6, the operation of the present invention has been described thus far in a mode of operation where a user first transfers sufficient funds to receive credit in his virtual account prior to requesting transfer of payment to another party. In many cases, it may be preferable to work in the reverse mode in which a “send money” request may be made without sufficient funds already present in the virtual account. In other words, step 38 of FIG. 4 may occur prior to steps 32 and 36. FIG. 6 illustrates the preferred operation of the system as relates to such cases.

Specifically, after receipt of a “send money” request at 68, the system first verifies the balance in the corresponding virtual account (step 70). If the balance is insufficient to complete the requested payment, the system preferably sends a “request money” request for transfer of funds from the user's account on his local online payment system to the local brokerage account 12 (step 72). If the credit in the virtual account is sufficient to complete the transaction, or alternatively, when sufficient funds are received, the system proceeds to debit the virtual account and implement the requested payment (step 74) as described above.

Turning finally to FIG. 7, as mentioned above in the context of currency conversion, the local brokerage account in each online payment system preferably serves both for incoming and outgoing transfers within the given online payment system, and therefore inherently tends to maintain a roughly constant credit level without requiring deposits and withdrawals to the local brokerage accounts. It is possible, however, that the nature of commerce conducted, especially international commerce, may in some cases result in significantly uneven cash flow situations where users on one O.P.S. predominantly purchase goods while those on another O.P.S. predominantly sell goods. System 10 therefore preferably provides a local brokerage account management process as illustrated in FIG. 7.

Thus, system 10 monitors the balance in each local brokerage account (step 76) and compares the balance with minimum and maximum threshold values. If the balance falls below a minimum threshold, system 10 initiates a transfer of funds into the local brokerage account (step 78). If the balance exceeds a maximum threshold, system 10 preferably initiates withdrawal of excess funds from the account (step 80). Most preferably, system 10 also performs statistical analysis on the fluctuations in the account balance in order to better estimate what range of incoming and outgoing transactions the system is being exposed to and adaptively adjusts the minimum and maximum threshold values accordingly (step 82).

It will be appreciated that the above descriptions are intended only to serve as examples, and that many other embodiments are possible within the scope of the present invention as defined in the appended claims.

What is claimed is:

1. A method for performing financial transactions involving a plurality of online payment systems comprising:
(a) opening a first and a second local brokerage account with a first and a second online payment system, respectively;
(b) receiving from a user of the first online payment system a first electronic money transfer within said first online payment system from an account of the user to the first local brokerage account;
(c) crediting a virtual account of the user with a value of electronic money related to said first electronic money transfer;
(d) receiving from the user a request to complete a payment to a vendor having a vendor account on the second online payment system;
(e) debiting the virtual account of the user with a value of electronic money related to the requested payment; and
(f) transferring the requested payment within the second online payment system from the second local brokerage account to the vendor account.

2. The method of claim 1, further comprising retrieving a current exchange rate between two currencies interrelated by a fluctuating rate of exchange, said current exchange rate being used in calculating the value of electronic money for at least one of said crediting and said debiting.

3. The method of claim 1, further comprising performing an initial registration procedure for at least one user, the registration procedure including inputting information sufficient to identify a user account associated with the user on one of the plurality of online payment systems.

4. The method of claim 1, further comprising identifying receipt of electronic money transfers from users of the second online payment system to said second local brokerage account, and transferring requested payments from the first local brokerage account to vendor accounts within the first online payment system.

5. A universal e-money system for performing financial transactions involving a plurality of online payment systems, the system comprising:
(a) a first and a second local brokerage account opened with a first and a second online payment system, respectively;
(b) a plurality of software modules programmed in a computer of a data network, said computer being in communication with the plurality of online payment systems, said plurality of modules being configured to:
(i) interface with the first online payment system to identify receipt from a user of the first online payment system of a first electronic money transfer within the first online payment system from an account of the user to said first local brokerage account;
(ii) credit a virtual account of the user with a value of electronic money related to said first electronic money transfer;
(iii) interface with the user to receive from the user a request to complete a payment to a vendor having a vendor account on the second online payment system;
(iv) debit the virtual account of the user with a value of electronic money related to the requested payment; and
(v) interface with the second online payment system to transfer the requested payment within the second online payment system from said second local brokerage account to the vendor account.

6. The system of claim 5, wherein said plurality of modules is further configured to retrieve a current exchange rate between two currencies interrelated by a fluctuating rate of exchange, said current exchange rate being used in calculating at least one of the value of electronic money to credit the virtual account and the value of electronic money to debit the virtual account.

7. The system of claim 5, wherein said plurality of modules is further configured to interface with at least one user to perform an initial registration procedure, the registration procedure including inputting information sufficient to identify a user account associated with the user on one of the plurality of online payment systems.

8. The system of claim 5, wherein said plurality of modules is further configured to interface with the second online payment system to identify receipt of electronic money transfers from users of the second online payment system to said second local brokerage account, and to interface with said first online payment system to transfer requested payments from the first local brokerage account to vendor accounts within the first online payment system.

9. A program storage device readable by a machine, tangibly embodying a program of instructions executable by the machine to perform a method for performing financial transactions between users of a first and a second online payment system within which have been opened a first and a second local brokerage account, respectively, the method comprising the steps of:
(a) receiving from a user of the first online payment system a first electronic money transfer within said first online payment system from an account of the user to the first local brokerage account;
(b) crediting a virtual account of the user with a value of electronic money related to said first electronic money transfer;
(c) receiving from the user a request to complete a payment to a vendor having a vendor account on the second online payment system;
(d) debiting the virtual account of the user with a value of electronic money related to the requested payment; and
(e) transferring the requested payment within the second online payment system from the second local brokerage account to the vendor account.

10. The program storage device of claim 9, wherein the method performed by the machine executing the program of instructions further includes retrieving a current exchange rate between two currencies interrelated by a fluctuating rate of exchange, said current exchange rate being used in calculating the value of electronic money for at least one of said crediting and said debiting.

11. The program storage device of claim 9, wherein the method performed by the machine executing the program of instructions further includes performing an initial registration procedure for at least one user, the registration procedure including inputting information sufficient to identify a user account associated with the user on one of the plurality of online payment systems.

12. The program storage device of claim 9, wherein the method performed by the machine executing the program of instructions further includes identifying receipt of electronic money transfers from users of the second online payment system to said second local brokerage account, and transferring requested payments from the first local brokerage account to vendor accounts within the first online payment system.
